(19) United States
(12) Patent Application Publication
(10) Pub. No.: US 2016/0108191 A1
(43) Pub. Date: Apr. 21, 2016

(54) OPAQUE PP/PLA BOPP FILMS WITH BROAD PROCESSING WINDOW

(71) Applicant: FINA TECHNOLOGY, INC., Houston, TX (US)

(72) Inventors: Fengkui Li, Houston, TX (US); John Ashbaugh, Houston, TX (US)

(21) Appl. No.: 14/518,112

(22) Filed: Oct. 20, 2014

(51) Int. Cl. C08J 5/18

(52) U.S. Cl. CPC C08J 5/18; C08J 2323/12; C08J 2467/04; C08J 2423/26

(57) ABSTRACT

A film having a polypropylene and polylactic acid blend having a haze of from about 10% to about 100% and a gloss 45° of from about 20 to about 150.

### CROSS-REFERENCE TO RELATED APPLICATIONS

None

### STATEMENT REGARDING FEDERALLY SPONSORED RESEARCH OR DEVELOPMENT

Not applicable.

### REFERENCE TO A MICROFICHE APPENDIX

Not applicable

### BACKGROUND

1. Technical Field

This disclosure relates to polymeric compositions including a biodegradable polymer.

2. Background

Articles constructed from certain synthetic polymeric materials have widespread utility, but may remain semi-permanently in a natural environment. Certain biodegradable polymers may be used in conjunction with these synthetic polymeric materials to form articles that may degrade more rapidly than articles made solely with synthetic polymeric materials.

### SUMMARY

An embodiment of the present disclosure includes a film having a polylactic acid and polypropylene blend having a haze of from about 10% to about 100% and a 45° gloss of from about 50 to about 150.

Another embodiment of the present disclosure includes a film having a polylactic acid and polypropylene blend having a haze of about 100% and a 45° gloss of from about 125 to about 150.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is graph depicting haze (%) of films as described in Example 1 consistent with at least one embodiment of the present disclosure.

FIG. 2 is a graph depicting haze (%) of films as described in Example 2 consistent with at least one embodiment of the present disclosure.

FIG. 3 is a graph of endotherms vs. temperature at DSC first melt of PLA resins used for making samples in Example 2 consistent with at least one embodiment of the present disclosure.

FIG. 4 is a graph depicting haze (%) versus process temperature as described in Example 3 consistent with at least one embodiment of the present disclosure.

FIG. 5 is graph depicting haze versus processing temperature as described in Example 4 consistent with at least one embodiment of the present disclosure.

FIG. 6 is a graph depicting gloss versus processing temperature as described in Example 4 consistent with at least one embodiment of the present disclosure.

FIG. 7 is a graph depicting MD stretch yield strength versus processing temperature as described in Example 4 consistent with at least one embodiment of the present disclosure.

### DETAILED DESCRIPTION

A detailed description will now be provided. The description includes specific embodiments, versions and examples, but the disclosure is not limited to these embodiments, versions or examples, which are included to enable a person having ordinary skill in the art to make and use the disclosure when that information is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Disclosed herein are polymeric compositions and articles made therefrom. In some embodiments, the polymeric compositions include polyolefins, including, but not limited to polyethylene and polypropylene. Non-limiting examples of suitable polyolefins in this disclosure include homopolymers and copolymers of polypropylene and polyethylene or blends of polypropylene and polyethylene.

In an embodiment, the polyolefin is polypropylene. The polypropylene may be a homopolymer provided however that the homopolymer may contain up to 5% of another alpha-olefin, including but not limited to C₂-C₈ alpha-olefins such as ethylene and 1-butene. Despite the potential presence of small amounts of other alpha-olefins, the polypropylene is generally referred to as a polypropylene homopolymer.

Polypropylene homopolymers suitable for use in this disclosure may include any type of polypropylene known in the art with the aid of this disclosure. For example, the polypropylene homopolymer may be atactic polypropylene, isotactic polypropylene, hemi-isotactic, syndiotactic polypropylene, or combinations thereof. A polymer is “atactic” when its pendant groups are arranged in a random fashion on both sides of the chain of the polymer. In contrast, a polymer is “isotactic” when all of its pendant groups are arranged on the same side of the chain and “syndiotactic” when its pendant groups alternate on opposite sides of the chain. In hemi-isotactic polymer, every other repeat unit has a random substituent.

In an embodiment, a polypropylene homopolymer suitable for use in this disclosure may have a density of from 0.895 g/cc to 0.920 g/cc, alternatively from 0.900 g/cc to 0.915 g/cc, and alternatively from 0.905 g/cc to 0.915 g/cc as determined in accordance with ASTM D1505; a melting temperature of from 150° C. to 170° C., alternatively from 155° C. to 168° C., and alternatively from 160° C. to 165° C. as determined by differential scanning calorimetry; a melt flow rate of from 0.5 g/10 min. to 50 g/10 min., alternatively from 1.0 g/10 min. to 10 g/10 min., and alternatively from 1.5 g/10 min. to 5.0 g/10 min. as determined in accordance with ASTM D1238 condition “L”; a tensile modulus of from 200,000 psi to 350,000 psi; alternatively from 220,000 psi to 320,000 psi, and alternatively from 250,000 psi to 320,000 psi as determined in accordance with ASTM D638; a tensile stress at yield of from 3,000 psi to 6,000 psi, alternatively from 3,500 psi to 5,500 psi, and alternatively from 4,000 psi to 5,500 psi as determined in accordance with ASTM D638; a tensile strain at yield of from 5% to 30%, alternatively from 5% to 20%, and alternatively from 5% to 15% as determined in accordance with ASTM D638; a flexural modulus of from 120,000 psi to 330,000 psi, alternatively from 190,000 psi to 310,000 psi, and alternatively of from 220,000 psi to 300,000 psi as determined in accordance with ASTM D790; a Gardner impact of from 3 in-lb to 50 in-lb, alternatively from 5 in-lb to 30 in-lb, and alternatively from 9 in-lb to 25 in-lb as determined in accordance with ASTM D2463; a Notched Izod Impact Strength of from 0.2 ft lb/in to 20 ft lb/in, alternatively from 0.5 ft lb/in to 15 ft lb/in, and alternatively from 0.5 ft lb/in to 10 ft lb/in as determined in accordance with ASTM D256A; a hardness shore D of from 30 to 90, alternatively from 50 to 85, and alternatively from 60 to 80 as determined in accordance with ASTM D2240; and a heat distortion temperature of from 50° C. to 125° C., alternatively from 80° C. to 115° C., and alternatively from 90° C. to 110° C. as determined in accordance with ASTM D648.

Examples of polypropylene homopolymers suitable for use in this disclosure include without limitation 3371, 3271, 3270, and 3276, which are polypropylene homopolymers commercially available from Total Petrochemicals USA, Inc. In an embodiment, the polypropylene homopolymer (e.g., 3371) has generally the physical properties set forth in Table 1.

TABLE 1

| | | |
|---|---|---|
| | 3371 | |
| Properties | Typical Value | Test Method |

Physical

| | | |
|---|---|---|
| Density, g/cc | 0.905 | ASTM D1505 |
| Melt Flow Rate (MFR), g/10 min. | 2.8 | ASTM D1238 |
| | | condition “L” |

Mechanical

| | | |
|---|---|---|
| Tensile Modulus, psi | 235,000 | ASTM D638 |
| Tensile Stress at Yield, psi | 5,100 | ASTM D638 |
| Tensile Strain at Yield, % | 7.5 | ASTM D638 |
| Flexural Modulus, psi | 202,000 | ASTM D790 |

Impact

| | | |
|---|---|---|
| Gardner impact, in-lb | 149.2 | ASTM D2463 |
| Notched Izod Impact Strength, ft lb/in | 0.69 | ASTM D256A |

Hardness

| | | |
|---|---|---|
| Hardness Shore D | 75 | ASTM D2240 |

Thermal

| | | |
|---|---|---|
| Heat distortion temperature, ° F. | 207 | ASTM D648 |
| Melting Temperature (DSC), ° F. | 325 | DSC |

In another embodiment, the polypropylene may be a high crystallinity polypropylene homopolymer (HCPP). The HCPP may contain primarily isotactic polypropylene. The isotacticity in polymers may be measured via ¹³C NMR spectroscopy using meso pentads and can be expressed as percentage of meso pentads (% mmmm). As used herein, the term “meso pentads” refers to successive methyl groups located on the same side of the polymer chain. In an embodiment, the HCPP has a meso pentads percentage of greater than 97%, or greater than 98%, or greater than 99%. The HCPP may comprise some amount of atactic or amorphous polymer. The atactic portion of the polymer is soluble in xylene, and is thus termed the xylene soluble fraction (XS %). In determining XS %, the polymer is dissolved in boiling xylene and then the solution cooled to 0° C. that results in the precipitation of the isotactic or crystalline portion of the polymer. The XS % is that portion of the original amount that remained soluble in the cold xylene. Consequently, the XS % in the polymer is indicative of the extent of crystalline polymer formed. The total amount of polymer (100%) is the sum of the xylene soluble fraction and the xylene insoluble fraction, as determined in accordance with ASTM D5492-98. In an embodiment, the HCPP has a xylene soluble fraction of less than 1.5%, or less than 1.0%, or less than 0.5%.

In an embodiment, an HCPP suitable for use in this disclosure may have a density of from 0.895 g/cc to 0.920 g/cc, alternatively from 0.900 g/cc to 0.915 g/cc, and alternatively from 0.905 g/cc to 0.915 g/cc as determined in accordance with ASTM D1505; a melt flow rate of from 0.5 g/10 min. to 500 g/10 min., alternatively from 1.0 g/10 min. to 100 g/10 min., and alternatively from 1.5 g/10 min. to 20 g/10 min. as determined in accordance with ASTM D1238; a secant modulus in the machine direction (MD) of from 350,000 psi to 420,000 psi; alternatively from 380,000 psi to 420,000 psi, and alternatively from 400,000 psi to 420,000 psi as determined in accordance with ASTM D882; a secant modulus in the transverse direction (TD) of from 400,000 psi to 700,000 psi, alternatively from 500,000 psi to 700,000 psi, and alternatively from 600,000 psi to 700,000 psi as determined in accordance with ASTM D882; a tensile strength at break in the MD of from 19,000 psi to 28,000 psi, alternatively from 22,000 psi to 28,000 psi, and alternatively from 25,000 psi to 28,000 psi as determined in accordance with ASTM D882; a tensile strength at break in the TD of from 20,000 psi to 40,000 psi, alternatively from 30,000 psi to 40,000 psi, and alternatively of from 35,000 psi to 40,000 psi as determined in accordance with ASTM D882; an elongation at break in the MD from 50% to 200%, alternatively from 100% to 180%, and alternatively from 120% to 150% as determined in accordance with ASTM D882; an elongation at break in the TD of from 50% to 150%, alternatively from 60% to 100%, and alternatively from 80% to 100% as determined in accordance with ASTM D882; a melting temperature of from 150° C. to 170° C., alternatively from 155° C. to 170° C., and alternatively from 160° C. to 170° C. as determined by differential scanning calorimetry; a gloss at 45° of from 70 to 95, alternatively from 75 to 90, and alternatively from 80 to 90 as determined in accordance with ASTM D2457; a percentage haze of from 0.5% to 2.0%, alternatively from 0.5% to 1.5%, and alternatively from 0.5% to 1.0% as determined in accordance with ASTM D1003; and a water vapor transmission rate of from 0.15 to 0.30 g-mil/100 in²/day, alternatively from 0.15 to 0.25 g-mil/100 in²/day, and alternatively from 0.20 to 0.21 g-mil/100 in²/day as determined in accordance with ASTM F-1249-90.

An example of an HCPP suitable for use in this disclosure includes without limitation 3270, which is an HCPP commercially available from Total Petrochemicals USA, Inc. The HCPP (e.g., 3270) may generally have the physical properties set forth in Table 2.

TABLE 2

| | | |
|---|---|---|
| | 3270 | |
| Properties | Typical Value | Test Method |

Physical

| | | |
|---|---|---|
| Density, g/cc | 0.910 | ASTM D1505 |
| Melt Mass-Flow Rate (MFR) | 2.0 | ASTM D1238 |
| (230° C./2.16 kg), g/10 min. | | |

BOPP Mechanical

| | | |
|---|---|---|
| Secant Modulus MD, psi | 420,000 | ASTM 882 |
| Secant Modulus TD, psi | 700,000 | ASTM 882 |
| Tensile Strength at Break MD, psi | 28,000 | ASTM 882 |
| Tensile Strength at Break TD, psi | 39,000 | ASTM 882 |
| Elongation at Break MD, % | 150 | ASTM 882 |
| Elongation at Break TD, % | 60 | ASTM 882 |

Thermal

| | | |
|---|---|---|
| Melting Temperature, ° F. | 329 | DSC |

Optical

| | | |
|---|---|---|
| Gloss (45°) | 85 | ASTM D2457 |
| Haze, % | 1.0 | ASTM D1003 |

Barrier

| | | |
|---|---|---|
| Water Vapor Transmission, 100° F., | 0.2 | ASTM F1249- |
| 90% R.H, g-mil/100 in²/day | | 90 |

In another embodiment, the polypropylene may be a polypropylene copolymer. In certain embodiments, the polypropylene copolymer may be a propylene random copolymer, including, for example, LX 02-15, a metallocene-manufactured polypropylene commercially available from Total Petrochemicals USA, Inc. Other examples of polypropylene copolymers include propylene random copolymers made from Zieger-Natta catalysts, such as the 6000-, 7000-, and 8000-series commercially available from Total Petrochemicals USA, Inc.

In other embodiments, the polypropylene copolymer may be a polypropylene heterophasic copolymer (PPHC) wherein a polypropylene homopolymer phase or component is joined to a copolymer phase or component. The PPHC may comprise from greater than 6.5 wt. % to less than 20 wt. % ethylene by total weight of the PPHC, alternatively from 8.5 wt. % to less than 18 wt. %, alternatively from 9.5 wt. % to less than 16%.

The copolymer phase of a PPHC may be a random copolymer of propylene and ethylene, also referred to as an ethylene/propylene rubber (EPR). PP heterophasic copolymers show distinct homopolymer phases that are interrupted by short sequences or blocks having a random arrangement of ethylene and propylene. In comparison to random copolymers, the block segments comprising the EPR may have certain polymeric characteristics (e.g., intrinsic viscosity) that differ from that of the copolymer as a whole. Without wishing to be limited by theory, the EPR portion of the PPHC has rubbery characteristics which, when incorporated within the matrix of the homopolymer component, may function to provide increased impact strength to the PPHC. In an embodiment, the EPR portion of the PPHC comprises greater than 14 wt. % of the PPHC, alternatively greater than 18 wt. % of the PPHC, alternatively from 14 wt. % to 18 wt. % of the PPHC.

The amount of ethylene present in the EPR portion of the PPHC may be from 38 wt. % to 50 wt. %, alternatively from 40 wt. % to 45 wt. % based on the total weight of the EPR portion. The amount of ethylene present in the EPR portion of the PPHC may be determined spectrophotometrically using a fourier transform infrared spectroscopy (FTIR) method. Specifically, the FTIR spectrum of a polymeric sample is recorded for a series of samples having a known EPR ethylene content. The ratio of transmittance at 720 cm⁻¹/900 cm⁻¹ is calculated for each ethylene concentration and a calibration curve may then be constructed. Linear regression analysis on the calibration curve can then be carried out to derive an equation that is then used to determine the EPR ethylene content for a sample material.

The EPR portion of the PPHC may exhibit an intrinsic viscosity different from that of the propylene homopolymer component. Herein intrinsic viscosity refers to the capability of a polymer in solution to increase the viscosity of said solution. Viscosity is defined herein as the resistance to flow due to internal friction. In an embodiment, the intrinsic viscosity of the EPR portion of the PPHC may be greater than 1 dl/g, alternatively from 2.0 dl/g to 3.0 dl/g, alternatively from 2.4 dl/g to 3.0 dl/g, alternatively from 2.4 dl/g to 2.7 dl/g, alternatively from 2.6 dl/g to 2.8 dl/g. The intrinsic viscosity of the EPR portion of the PPHC is determined in accordance with ASTM D5225.

In an embodiment, the PPHC may have a melt flow rate (MFR) of from 0.5 g/10 min. to 500 g/10 min., alternatively from 1 g/10 min. to 100 g/10 min., alternatively from 1.5 g/10 min. to 50 g/10 min., alternatively from 2.0 g/10 min. to 20 g/10 min. Excellent flow properties as indicated by a high MFR allow for high throughput manufacturing of molded polymeric components. In an embodiment, the PPHC is a reactor grade resin without modification, which may also be termed a low order PP. In some embodiments, the PPHC is a controlled rheology grade resin, wherein the melt flow rate has been adjusted by various techniques such as visbreaking. For example, MFR may be increased by visbreaking as described in U.S. Pat. No. 6,503,990, which is incorporated by reference in its entirety. As described in that publication, quantities of peroxide are mixed with polymer resin in flake, powder, or pellet form to increase the MFR of the resin. MFR as defined herein refers to the quantity of a melted polymer resin that will flow through an orifice at a specified temperature and under a specified load. The MFR may be determined using a dead-weight piston Plastometer that extrudes polypropylene through an orifice of specified dimensions at a temperature of 230° C. and a load of 2.16 kg in accordance with ASTM D1238.

Representative examples of suitable PPHCs include without limitation 4920W and 4920WZ, which are impact copolymer resins commercially available from Total Petrochemicals USA Inc. In an embodiment, the PPHC (e.g., 4920W) has generally the physical properties set forth in Table 3.

TABLE 3

| | | |
|---|---|---|
| Properties | Typical Value | ASTM Method |

Physical (resin)

| | | |
|---|---|---|
| Melt Flow, g/10 min. | 100 | D1238 |
| Density, g/cc | 0.905 | D1505 |
| Melting Point, ° C. | 160-165 | DSC |

Mechanical

| | | |
|---|---|---|
| Tensile strength at Yield, psi (MPa) | 3700 (25) | D638 |
| Elongation at Yield, % | 6 | D638 |
| Flexural Modulus, psi (MPa) | 190,000 (1,300) | D790 |
| Notched, ft.lb./in. (J/m) | 1.0 (50) | ASTM D256A |

Thermal

| | | |
|---|---|---|
| Heat Deflection, ° C. | 90 | D648 |

In another embodiment, the polypropylene is a high melt strength polypropylene. A high melt strength polypropylene may be a semi-crystalline polypropylene or polypropylene copolymer matrix containing a heterophasic copolymer. The heterophasic copolymer may include ethylene and higher alpha-olefin polymer such as amorphous ethylene-propylene copolymer, for example.

In an embodiment, the polyolefin is polyethylene, alternatively high density polyethylene, alternatively low density polyethylene, alternatively linear low density polyethylene.

In an embodiment, the polyolefin comprises high density polyethylene (HDPE). Herein an HDPE has a density of equal to or greater than 0.941 g/cc, alternatively from 0.941 g/cc to 0.965 g/cc, alternatively from 0.945 g/cc to 0.960 g/cc. The HDPE may be a homopolymer or a copolymer, for example a copolymer of ethylene with one or more alpha-olefin monomers such as propylene, butene, hexene, etc. In an embodiment, the HDPE is a homopolymer. An HDPE suitable for use in this disclosure may generally have a melt-mass flow rate, determined by ASTM D1238, of from 0.01 g/10 min. to 50 g/10 min., or from 0.5 g/10 min. to 20 g/10 min., or from 1.0 g/10 min. to 10 g/10 min. In an embodiment, an HDPE suitable for use in this disclosure may generally have a tensile modulus, determined by ASTM D638, of from 100,000 psi to 350,000 psi, or from 150,000 psi to 300,000 psi, or from 180,000 psi to 220,000 psi. In an embodiment, an HDPE suitable for use in this disclosure may generally have a flexural modulus, determined by ASTM D790, of from 30,000 psi to 350,000 psi, or from 100,000 psi to 300,000 psi, or from 150,000 psi to 200,000 psi. In an embodiment, an HDPE suitable for use in this disclosure may generally have a melting temperature, determined by differential scanning calorimetry (DSC), of from 120° C. to 140° C., or from 125° C. to 135° C., or from 130° C. to 133° C.

Examples of HDPEs suitable for use in this disclosure include without limitation 6450 HDPE which is a polyethylene resin and mPE ER 2283 POLYETHYLENE which is a metallocene high density polyethylene resin with hexene as comonomer, both are commercially available from Total Petrochemicals USA, Inc. In an embodiment, a suitable HDPE has generally the physical properties set forth in Table 4 (e.g., 6450 HDEP) or Table 5 (e.g., ER 2283).

TABLE 4

| | | |
|---|---|---|
| Properties | Typical Value | ASTM Method |

Resin⁽¹⁾

| | | |
|---|---|---|
| Melt Flow Index 190° C./2.16 kg, | 5.0 | D 1238 |
| g/10 min | | |
| Density, g/cm³ | 0.962 | D 792 |
| Melting Point, ° F. | 265 | D 3417 |
| Film⁽¹⁾⁽²⁾ | | |

Haze, %

| | | |
|---|---|---|
| Gloss, % | 85 | D 523 |
| Tensile Strength @ Break (MD), psi | 3500 | D 882 |
| Tensile Strength @ Break (TD), psi | 3800 | D 882 |
| Elongation @ Break (MD), % | 850 | D 882 |
| Elongation @ Break (TD), % | 650 | D 882 |
| Secant Modulus @ 2% Strain (MD), psi | 100,000 | D 882 |
| Secant Modulus @ 2% Strain (TD), psi | 130,000 | D 882 |
| WVTR⁽³⁾ @ 100° F., g/100 in²/day | 0.5 | E 96/66 |
| Low Temp. Brittleness, ° F. | <−112 | D 746 |

⁽¹⁾Data developed under laboratory conditions and are not to be used as specification, maxima or minima.
⁽²⁾The data listed were determined on 1.0 mil cast film.
⁽³⁾Water Vapor Transmission Rate.

TABLE 5

| | | | |
|---|---|---|---|
| Properties | Method | Unit | Value |

Physical

| | | | |
|---|---|---|---|
| Density | ISO 1183 | g/cm³ | 0.950 |
| Melt Index (2.16 kg) | ISO 1133 | g/10 min | 2.0 |
| Melting Point | EN ISO 11357 | ° C. | 133 |
| Vicat Temperature | ISO 306 | ° C. | 130 |

Cast Film

| | | | |
|---|---|---|---|
| Dart Impact | ISO 7765-1 | g | 36 |
| Tensile Strength at Yield MD/TD | ISO 527-3 | MPa | 23/24 |
| Tensile Strength at Break MD/TD | ISO 527-3 | MPa | 43/41 |
| Elongation at Break MD/TD | ISO 527-3 | % | 640/820 |
| Elmendorf MD/TD | ISO 6393 | N/mm | 8/130 |
| Haze | ISO 14782 | % | 10 |
| Gloss 45° | ASTM D 2457 | | 68 |

In an embodiment, the polyolefin comprises a low density polyethylene (LDPE). Herein an LDPE is defined as having a density range of from 0.910 g/cm³ to 0.940 g/cm³, alternatively from 0.917 g/cm³ to 0.935 g/cm³, and alternatively from 0.920 g/cm³ to 0.930 g/cm³. The LDPE may be further characterized by the presence of increased branching when compared to an HDPE. The LDPE may be a homopolymer or a copolymer, for example a copolymer of ethylene with one or more alpha-olefin monomers such as propylene, butene, hexene, etc. In an embodiment, the LDPE is a homopolymer. An LDPE suitable for use in this disclosure may generally have a melt-mass flow rate, determined by ASTM D1238, of from 0.1 g/10 min. to 60 g/10 min., or from 0.5 g/10 min. to 30 g/10 min., or from 1 g/10 min. to 20 g/10 min. In an embodiment, an LDPE suitable for use in this disclosure may generally have a tensile modulus, determined by ASTM D638, of from 10,000 psi to 70,000 psi, or from 15,000 psi to 65,000 psi, or from 20,000 psi to 60,000 psi. In an embodiment, an LDPE suitable for use in this disclosure may generally have a flexural modulus, determined by ASTM D790, of from 9,000 psi to 60,000 psi, or from 10,000 psi to 55,000 psi, or from 15,000 psi to 50,000 psi. In an embodiment, an LDPE suitable for use in this disclosure may generally have a melting temperature, determined by differential scanning calorimetry (DSC), of from 85° C. to 125° C., or from 90° C. to 120° C., or from 95° C. to 120° C.

A representative example of a suitable LDPE is 1020 FN 24, which is an LDPE commercially available from Total Petrochemicals USA, Inc. The LDPE (e.g., 1020 FN 24) may generally have the physical properties set forth in Table 6.

TABLE 6

| | | |
|---|---|---|
| English | SI | Method |

Nominal Resin Properties

| | | | |
|---|---|---|---|
| Density | — | 0.922 g/cm³ | ASTM D1505 |
| Melt Index, 190° C./2.16 Kg | — | 2.1 g/10 min | ASTM D1238 |
| Melting Point | 232° F. | 109° C. | ASTM D3418 |
| Vicat Softening Temperature | 209° F. | 94° C. | ASTM D1525 |

Nominal Blown Film Properties at 40 um⁽¹⁾

| | | | |
|---|---|---|---|
| Haze | 7.0% | 7.0% | ASTM D1003 |
| Tensile Strength at Yield MD/TD | 1595 psi/1523 psi | 11 MPa/10.5 MPa | ISO 527-3 |
| Tensile Strength at Break MD/TD | 4061 psi/3190 psi | 28/22 MPa | ISO 527-3 |
| Elongation at Break MD/TD | 360%/630% | 360%/630% | ISO 527-3 |
| Elmendorf MD/TD | — | 75/45 N/mm | ISO 6383-2 |
| Dart test | — | 120 g | ISO 7765-1 |
| Haze | 7% | 7% | ISO 14782 |

⁽¹⁾Data are obtained using laboratory test specimens produced with the following extrusion conditions: 45 mm screw diameter, L/D = 30, die diameter = 120 mm, die gap = 1.4 mm, BUR = 2.5:1, temperature = 185° C.

In an embodiment, the polyolefin comprises a linear low density polyethylene (LLDPE). LLDPE is a substantially linear polyethylene, with significant numbers of short branches. LLDPE is commonly generated by the copolymerization of ethylene with longer chain olefins. LLDPE differs structurally from low-density polyethylene because of the absence of long chain branching. In an embodiment, the LLDPE is a copolymer, for example a copolymer of ethylene with one or more alpha-olefin monomers such as propylene, butene, hexene, etc. An LLDPE suitable for use in this disclosure may generally have a density, determined by ASTM D792, of from 0.900 g/cc to 0.920 g/cc, or from 0.905 g/cc to 0.918 g/cc, or from 0.910 g/cc to 0.918 g/cc. In an embodiment, an LLDPE suitable for use in this disclosure may generally have a melt-mass flow rate, determined by ASTM D1238, of from 0.1 g/10 min. to 50 g/min., or from 0.5 g/10 min. to 30 g/10 min., or from 1 g/10 min. to 20 g/10 min. In an embodiment, an LLDPE suitable for use in this disclosure may generally have a tensile modulus, determined by ASTM D638, of from 20,000 psi to 250,000 psi, or from 50,000 psi to 220,000 psi, or from 100,000 psi to 200,000 psi. In an embodiment, an LLDPE suitable for use in this disclosure may generally have a flexural modulus, determined by ASTM D790, of from 5,000 psi to 150,000 psi, or from 10,000 psi to 130,000 psi, or from 50,000 psi to 110,000 psi. In an embodiment, an LLDPE suitable for use in this disclosure may generally have a melting temperature, determined by differential scanning calorimetry (DSC), of from 70° C. to 140° C., or from 80° C. to 130° C., or from 90° C. to 120° C.

A representative example of a suitable LLDPE is FINATHENE LL 4010 FE 18, which is an LLDPE commercially available from Total Petrochemicals. The LLDPE (e.g., FINATHENE LL 4010 FE 18) may generally have the physical properties set forth in Table 7.

TABLE 7

| | | |
|---|---|---|
| English | SI | Method |

Nominal Resin Properties

| | | | | |
|---|---|---|---|---|
| Density | — | 0.918 | g/cm³ | ASTM D792 |

| | | | |
|---|---|---|---|
| Melt Index | — | 1.0 g/10 min | ASTM D1238 |

Nominal Film Properties at 0.984 mil (25 um)

| Film Tensile Strength at | 1600 | psi | 11.0 | MPa | ISO 527 |
|---|---|---|---|---|---|
| Yield, MD | | | | | |
| Film Tensile Strength at | 1600 | psi | 11.0 | MPa | ISO 527 |
| Yield, TD | | | | | |
| Film Elongation at Break, MD | 600% | | 600% | | ISO 527 |
| Film Elongation at Break, TD | 750% | | 750% | | ISO 527 |
| Secant Modulus, MD | 23.2 | ksi | 0.160 | GPa | ISO 5527 |
| Secant Modulus, TD | 24.7 | ksi | 0.170 | GPa | ISO 5527 |
| Dart Drop Test | 0.198 | lb | 90.0 | g | ISO 7765-1 |
| Film Tensile Strength at | 5800 | psi | 40.0 | MPa | ISO 527 |
| Break, MD | | | | | |
| Film Tensile Strength at | 4350 | psi | 30.0 | MPa | ISO 527 |
| Break, TD | | | | | |

Thermal Properties

| | | | | | |
|---|---|---|---|---|---|
| Melting Point | 252° | F. | 122° | C. | ISO 11357-3 |

Optical Properties

| | | | |
|---|---|---|---|
| Haze | 10.0% | 10.0% | ASTM D 1003 |

Polyolefins suitable for use in this disclosure (e.g., polypropylene, polyethylene) may be prepared using any suitable method. For example, the polyolefin may be prepared using a Ziegler-Natta catalyst, metallocene catalyst, or combinations thereof. The polyethylene, for example, may be prepared using a chromium oxide catalyst, or any other suitable catalysts.

In an embodiment, the polyolefin is prepared using Ziegler-Natta catalysts, which are typically based on titanium and organometallic aluminum compounds, for example triethylaluminum (C₂H₅)₃Al. Ziegler-Natta catalysts and processes for forming such catalysts are described in U.S. Pat. Nos. 4,298,718; 4,544,717; and 4,767,735, each of which is incorporated by reference herein in its entirety.

In another embodiment, the polyolefin may be prepared using a metallocene catalyst. Metallocene catalysts may be characterized generally as coordination compounds incorporating one or more cyclopentadienyl (Cp) groups (which may be substituted or unsubstituted, each substitution being the same or different) coordinated with a transition metal through π bonding. Examples of metallocene catalysts and processes for forming such catalysts are described in U.S. Pat. Nos. 4,794,096 and 4,975,403, each of which is incorporated by reference herein in its entirety. Examples of polyolefins prepared through the use of metallocene catalysts are described in further detail in U.S. Pat. Nos. 5,158,920; 5,416,228; 5,789,502; 5,807,800; 5,968,864; 6,225,251; 6,777,366; 6,777,367; 6,579,962; 6,468,936; 6,579,962; and 6,432,860, each of which is incorporated by reference herein in its entirety.

The polyolefin may also be prepared using any other catalyst or catalyst system such as a combination of Ziegler-Natta and metallocene catalysts, for example as described in U.S. Pat. Nos. 7,056,991 and 6,653,254, each of which is incorporated by reference herein in its entirety.

The polyolefin may be formed by placing one or more olefin monomer (e.g., ethylene, propylene) alone or with other monomers in a suitable reaction vessel in the presence of a catalyst (e.g., Ziegler-Natta, metallocene, etc.) and under suitable reaction conditions for polymerization thereof. Any suitable equipment and processes for polymerizing the olefin into a polymer may be used. For example, such processes may include solution phase, gas phase, slurry phase, bulk phase, high pressure processes or combinations thereof. Such processes are described in detail in U.S. Pat. Nos. 5,525,678; 6,420,580; 6,380,328; 6,359,072; 6,346,586; 6,340,730; 6,339,134; 6,300,436; 6,274,684; 6,271,323; 6,248,845; 6,245,868; 6,245,705; 6,242,545; 6,211,105; 6,207,606; 6,180,735; and 6,147,173, which are incorporated herein by reference in their entirety.

In an embodiment, the polyolefin is formed by a gas phase polymerization process. One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from 100 psig to 500 psig, or from 200 psig to 400 psig, or from 250 psig to 350 psig. The reactor temperature in a gas phase process may vary from 30° C. to 120° C., or from 60° C. to 115° C., or from 70° C. to 110° C., or from 70° C. to 95° C., for example as described in U.S. Pat. Nos. 4,543,399; 4,588,790; 5,028,670; 5,317,036; 5,352,749; 5,405,922; 5,436,304; 5,456,471; 5,462,999; 5,616,661; 5,627,242; 5,665,818; 5,677,375; and 5,668,228, which are incorporated herein by reference in their entirety.

In an embodiment, the polyolefin is formed by a slurry phase polymerization process. Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene). The medium employed is generally liquid under the conditions of polymerization and relatively inert. A bulk phase process is similar to that of a slurry process. However, a process may be a bulk process, a slurry process or a bulk slurry process.

The polymeric composition of some embodiments of the present disclosure includes a polylactic acid as a cavitating agent. These polymeric blends are referred to hereinafter as PO/PLA blends. A cavitating agent refers to a compound(s) capable of generating voids in the structure of polyethylene.

Polylactic acid suitable for use in this disclosure may be of the type known in the art. For example, polylactic acid may include poly-L-lactide (PLLA), poly-D-lactide (PDLA), poly-LD-lactide (PDLLA), or combinations thereof. Modified polylactic acid is also suitable for use in this disclosure. Modified polylactic acid refers to stereocomplex polylactic acid and surface-modified polylactic acid, as described in Rahul M. Rasal et al., Poly (lactic acid) modifications, PROGRESS IN POLYMER SCIENCE 35 (2010) 338-356, which is incorporated herein fully by reference. Surface-modified polylactic acid includes, but is not limited to, coated polylactic acid, polylactic acid with entrapped biomacromolecules, polylactic acid blended with migratory additives, chemically conjugated polylactic acid, and polylactic acid that has been photografted. Polylactic acid may be prepared using any suitable method known to one of ordinary skill in the art. For example, polylactic acid may be prepared by dehydration condensation of lactic acid, such as described in U.S. Pat. No. 5,310,865, which is incorporated herein by reference in its entirety. Alternatively, polylactic acid may be prepared by synthesis of a cyclic lactide (also known as cyclic dimmer) from lactic acid followed by ring opening polymerization of the cyclic lactide. An example of such a process is described in U.S. Pat. No. 2,758,987, which is incorporated herein by reference in its entirety.

Catalysts may be used in the production of polylactic acid. The catalysts may be of any type suitable for the process. Examples of such catalysts include without limitation tin compounds such as tin octylate, titanium compounds such as tetraisopropyl titanate, zirconium compounds such as zirconium isopropoxide, and antimony compounds such as antimony trioxide.

In an embodiment, a polylactic acid suitable for use in this disclosure may have a density of from 1.238 g/cc to 1.265 g/cc, alternatively from 1.24 g/cc to 1.26 g/cc, and alternatively from 1.245 g/cc to 1.255 g/cc as determined in accordance with ASTM D792; a melt index of from 5 g/10 min. to 35 g/10 min. or alternatively from 15 g/10 min. to 30 g/10 min., as determined in accordance with ASTM D1238 at a temperature of 210° C. and a load of 2.16 kg; a crystalline melt temperature of from 150° C. to 180° C. or alternatively from 155° C. to 170° C.; a glass transition temperature of from 45° C. to 85° C., alternatively from 50° C. to 80° C., or alternatively from 55° C. to 60° C. as determined in accordance with ASTM D3417; a tensile yield strength of from 4,000 psi to 25,000 psi, alternatively from 5,000 psi to 20,000 psi, or alternatively from 8,000 psi to 10,000 psi as determined in accordance with ASTM D638; a tensile elongation of from 1.5% to 10%, alternatively from 2% to 8%, or alternatively of from 3% to 4% as determined in accordance with ASTM D638; a notched Izod impact of from less than 2 ft-lb/in, or between, 0.1 ft-lb/in to 0.8 ft-lb/in or from 0.2 ft-lb/in to 0.7 ft-lb/in, as determined in accordance with ASTM D256, and a DSC at first melt of between 150° C. and 170° C. or between 160° C. and 170° C. or between 169° C. and 170° C. Examples of polylactic acid suitable for use in this disclosure include without limitation PLA3251, PLA 4042, PLA 4060, PLA4202, and PLA6202, which are commercially available from Nature Works LLC.

In some embodiments, the PO/PLA blend may include between 50 and 99.5% PO and 0.5% to 50% PLA; or between 80% and 99.5% PO and 0.5% to 20% PLA; or between 90 and 95% PO and 10% to 5% PLA. All composition ratios are by weight of the components. In certain embodiments, the ratio of PO/PLA in the PO/PLA blend is between 1:1 and 199:1 or between 4:1 and 199:1, or between 9:1 and 19:1.

In certain embodiments of the present disclosure, the PO/PLA blend can contain between 1 and 20%, or between 5 and 15% or about 10% maleated polypropylene (all by weight) as a cavitating booster. A commercial maleated PP can be used for the functionalized polypropylene, such as for example Polybond 3150 or Polybond 3200, commercially available from Chemtura.

Examples of end use articles into which the PO/PLA blend may be formed include food packaging, office supplies, plastic lumber, replacement lumber, patio decking, structural supports, laminate flooring compositions, polymeric foam substrate; decorative surfaces (i.e., crown molding, etc.) weatherable outdoor materials, point-of-purchase signs and displays, house wares and consumer goods, building insulation, cosmetics packaging, outdoor replacement materials, lids and containers (i.e., for deli, fruit, candies and cookies), appliances, utensils, electronic parts, automotive parts, enclosures, protective head gear, reusable paintballs, toys (e.g., LEGO bricks), musical instruments, golf club heads, piping, business machines and telephone components, shower heads, door handles, faucet handles, wheel covers, automotive front grilles, and so forth. Additional end use articles would be apparent to those skilled in the art.

In an embodiment, the PO/PLA blends of this disclosure are used to prepare an injection molded article, including, without limitation, an injection blow molded article. In non-limiting examples, the injection blow molding process includes forming a pre-form and then biaxially stretching the pre-form.

In another embodiment, PO/PLA blends are used for the production of films, including non-oriented, uniaxially oriented, or biaxially oriented polypropylene (BOPP) films. As used herein, the term “biaxial orientation” refers to a process in which a polymeric composition is heated to a temperature at or above its glass-transition temperature but below its crystalline melting point. Immediately following heating, the material may then be extruded into a film, and stretched in both a longitudinal direction (i.e., the machine direction) and in a transverse or lateral direction (i.e., the tenter direction). Such stretching may be carried out simultaneously or sequentially.

In some embodiment, the PO/PLA blend is heated in an extruder. In certain of these embodiments, the PO/PLA blend may be mixed with an inorganic filler. The PO/PLA blend may be mixed with one or more inorganic fillers such as calcium carbonate, titanium dioxide, kaolin, alumina trihydrate, calcium sulfate, talc, mica, glass microspheres, or combinations thereof. The presence of such inorganic fillers may further increase the film opacity at a given film extrusion or stretching temperature over that of a film without such a filler, and may also extend the temperature window for forming opaque films. The inorganic fillers may be present in an amount of from 0.5 wt. % to 20 wt. %, alternatively from 1 wt. % to 15 wt. %, or alternatively from 0.5 wt. % to 10 wt. % of the total PO/PLA blend. In certain embodiments, the PO/PLA blend is not mixed with an inorganic filler.

The PO/PLA blend is heated in the extruder until molten. The molten polymer may then exit through a die and the molten plaque may be used to form an extruded film, a cast film, a biaxially oriented film, or the like. In an embodiment, the molten plaque may exit through the die and be taken up onto a roller without additional stretching to form an extruded film. Alternatively, the molten plaque may exit through the die and be uniaxially stretched while being taken up onto a chill roller where it is cooled to produce a cast film.

In an embodiment, the molten plaque exits through the die and is passed over a first roller (e.g., a chill roller) which solidifies the PO/PLA blend into a film. Then, the film may be biaxially oriented by stretching such film in a longitudinal direction and in a transverse direction. The longitudinal orientation may be accomplished through the use of two sequentially disposed rollers, the second (or fast roller) operating at a speed in relation to the slower roller corresponding to the desired orientation ratio. Longitudinal orientation may alternatively be accomplished through a series of rollers with increasing speeds, sometimes with additional intermediate rollers for temperature control and other functions.

After longitudinal orientation, the film may be cooled, pre-heated and passed into a lateral orientation section. The lateral orientation section may include, for example, a tenter frame mechanism, where the film is stressed in the transverse direction. Annealing and/or additional processing may follow such orientation. Alternatively, the film may be stretched in both directions at same time.

In other embodiments, the film may be stretched in a longitudinal and transverse direction simultaneously.

In some embodiments, the BOPO film made from the PO/PLA blend is stretched in the longitudinal direction, the transverse direction or both at a temperature of equal to or less than 160° C., or from 130° C. to 160° C., or from 140° C. to 155° C., or from 140° C. to 150° C. In certain embodiments, the stretch speed in the making of the BOPO film is up to 100 m/min, or up to 50 m/min of from 0.1 to 100 m/min in the longitudinal direction, the transverse direction or both.

Additional disclosure on biaxial film production may be found in U.S. Pat. No. 4,029,876 and U.S. Pat. No. 2,178,104, each of which is incorporated by reference herein in its entirety.

In certain embodiments of the disclosure, BOPO films are opaque. “Opaque” refers to a film with greater than or equal to 80% haze, as measured by ASTM-E-167. In some embodiments, CaCO₃ or a silica-based matting agent, such as that made by ACEMATT may also be added to the PO/PLA blend to increase the opacity of the BOPO. For instance, between 0 and 30% between 5 and 20% or about 10% by weight of CaCO₃ can be added to the PO/PLA blend or between 0 and 5000 ppm, or between 1000 and 3000 ppm or about 2500 ppm silica-based matting agent (all by weight) may be added to the PO/PLA blend, or both.

In certain embodiments of the present disclosure, the BOPO film has a haze of 10% to 100%, greater than 80%, greater than 90%, greater than 95%, greater than 99% or about 100% as measured by ASTM-E-167. In certain embodiments of the present disclosure, the BOPO film, when stretched biaxially at an oven temperature of above 140° C., has a haze of great than 80%, greater than 90%, greater than 95%, greater than 99% or about 100% as measured by ASTM-E-167. In certain embodiments of the present disclosure, the BOPO film, when stretched biaxially at an oven temperature of from about 140° C. to about 150° C., has a haze of great than 80%, greater than 90%, greater than 95%, greater than 99% or about 100% as measured by ASTM-E-167. In some embodiments, the BOPO films have a 45° gloss of greater than 50%, greater than 80%, or less than 150% as measured by ASTM-D-2457. In some embodiments, the BOPO film has a gloss of between 20% and 150%, 50% and 150%, or between 125% and 150%.

In certain embodiments of the present disclosure, the machine direction yield strength is measured during bi-axial stretching by a Bruckner lab stretcher that ranges from about 1 MPa to about 10 MPa or from about 1 MPa to about 8 MPa. In certain embodiments, the water vapor transmission rate of the BOPO films is between 0.80 and 0.95 g·day·100 in² or about 0.90 g·day·100 in² as measured by ASTM F1249. In certain embodiments, the opaque film density is between 0.50 and 0.70 g/cc or between 0.60 and 0.65 g/cc as measured by ASTM D792. In certain embodiments, the opaque film modulus is between 200 and 250 kpsi or between 230 and 240 kpsi, break strength between 12,000 and 23,000 psi or between 15,000 and 20,000 psi, and break elongation between 30% and 80%, as measured by ASTM D882.

In certain embodiments, the BOPO films are single layer films. In other embodiments, the BOPO films prepared from PO/PLA blends may form one or more layers of a multilayer film. The additional layers of the multilayer film may be any coextrudable film known in the art, such as syndiotactic polypropylene, low density polyethylene, linear low density polyethylene, medium density polyethylene, high density polyethylene, ethylene-propylene copolymers, butylenes-propylene copolymers, ethylene-butylene copolymers, ethylene-propylene-butylene terpolymers, ethylene-vinyl acetate copolymers, ethylene-vinyl alcohol copolymers, nylons, and the like, or combinations thereof.

### EXAMPLES

The disclosure having been generally described, the following examples show particular embodiments of the disclosure. It is understood that the example is given by way of illustration and is not intended to limit the specification or the claims. All compositions percentages given in the examples are by weight.

### Example 1

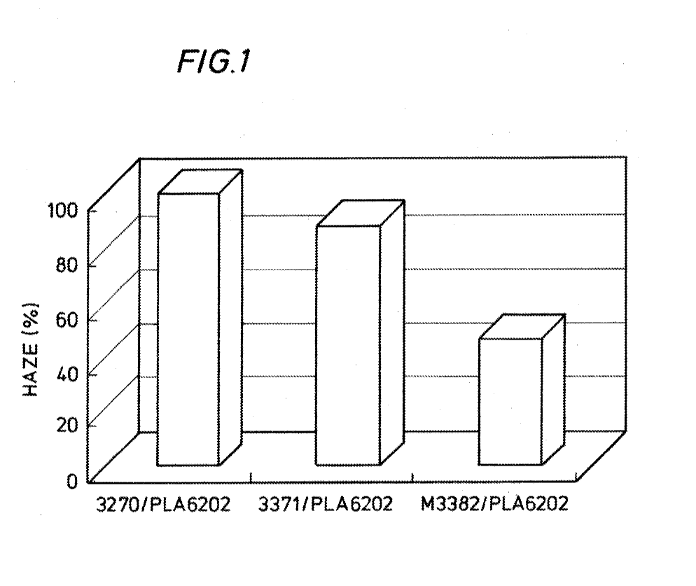

Samples of Total Petrochemicals polypropylene 3270, 3371, and M3382 were each blended with 10% NatureWorks PLA6202 and then cast into 16 mil thick sheets. The sheets were stretched bi-axially at an areal draw ratio of 6×6 and 30 m/min stretch speed at 140° C. on a Bruckner Karo IV lab stretcher. As shown in FIG. 1, with the same PLA, Total Petrochemicals high crystallinity polypropylene 3270 was easier to be cavitated, resulting in more opaque films. Under the same conditions, metallocene polypropylene as the base resin resulted in the least opaque films.

### Example 2

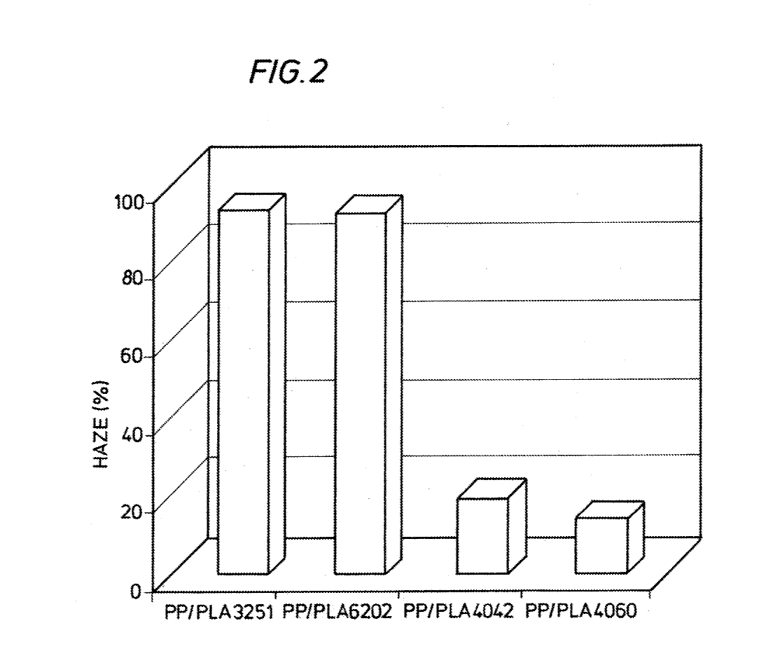

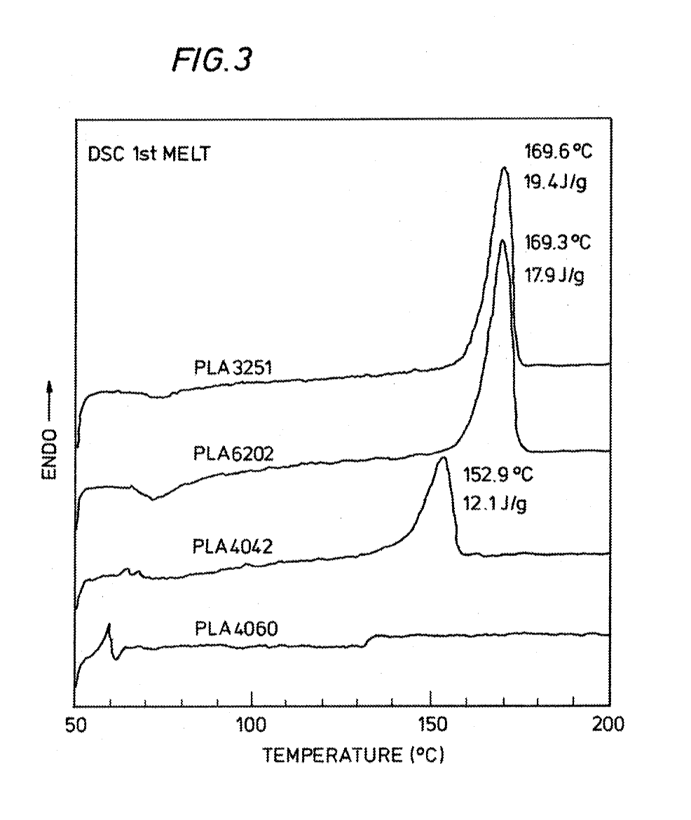

In Example 2, the process conditions of Example 1 were duplicated, except that different PLA resins were used to make the same films, with PP 3270 being used for the polypropylene. The haze (%) for each are show in FIG. 2. The endotherms for DSC first melts by temperature are shown in FIG. 3, along with energy required for the first melt. As shown in the FIGS. 2 and 3, NatureWorks PLA3251 and PLA6202 with a high melting point and a high degree of crystallinity were the most effective cavitating agents for making opaque BOPP.

### Example 3

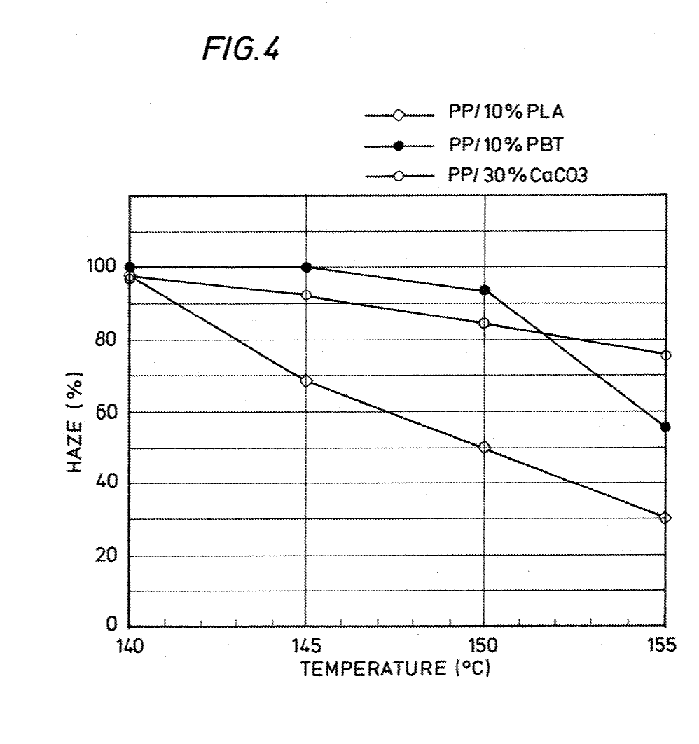

In Example 3, the process conditions of Example 1 were duplicated with variations in process temperatures, except that samples were made with 10% PLA 3251, 10% PBT (Polybutyl terephthalate), or 30% CaCO₃. Haze versus process temperature at orientation stretching is shown in FIG. 4.

### Example 4

In Example 4, the process conditions of Example 1 were duplicated with variations in stretch temperatures, except that the following were added to PP 3270 in different samples:

TABLE 1

| Sample # | Component |
|---|---|
| 1 | No additional components |
| 2 | 10% PLA3251 |
| 3 | 10% Polybutyl terephthalate |
| 4 | 10% CaCO₃ |
| 5 | 10% PLA 3251/10% CaCO₃ |
| 6 | 10% PLA3251/2500 ppm ACEmatt |

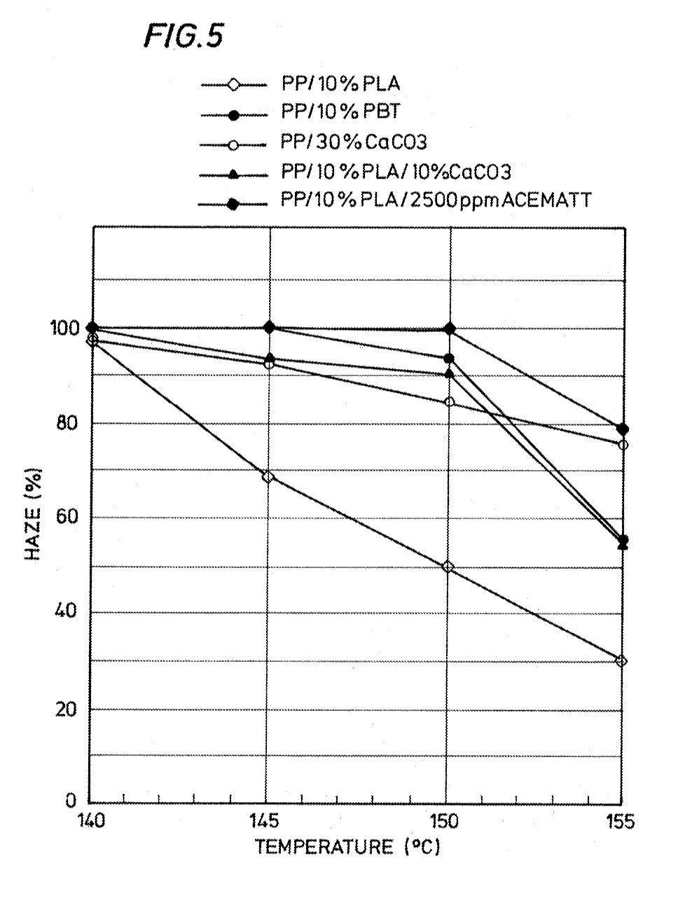

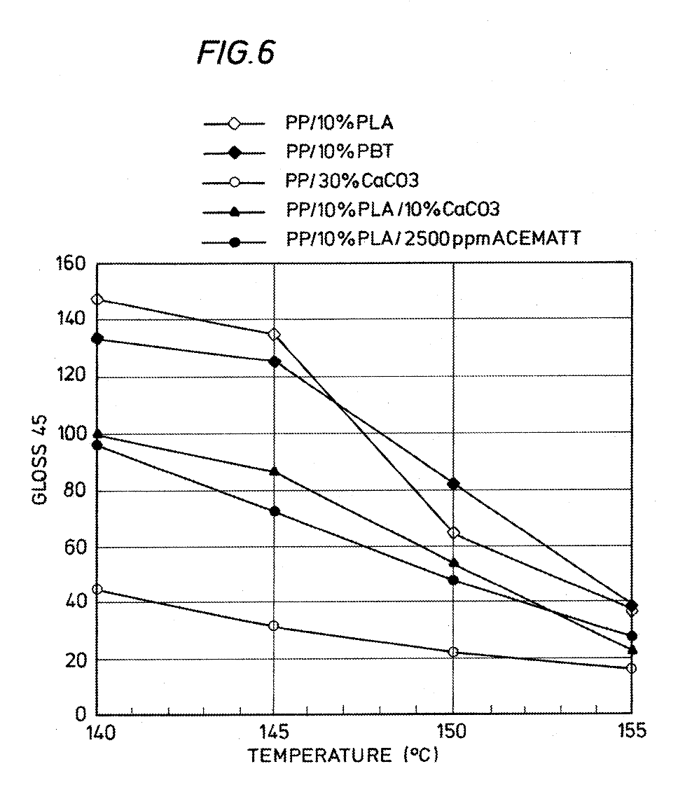

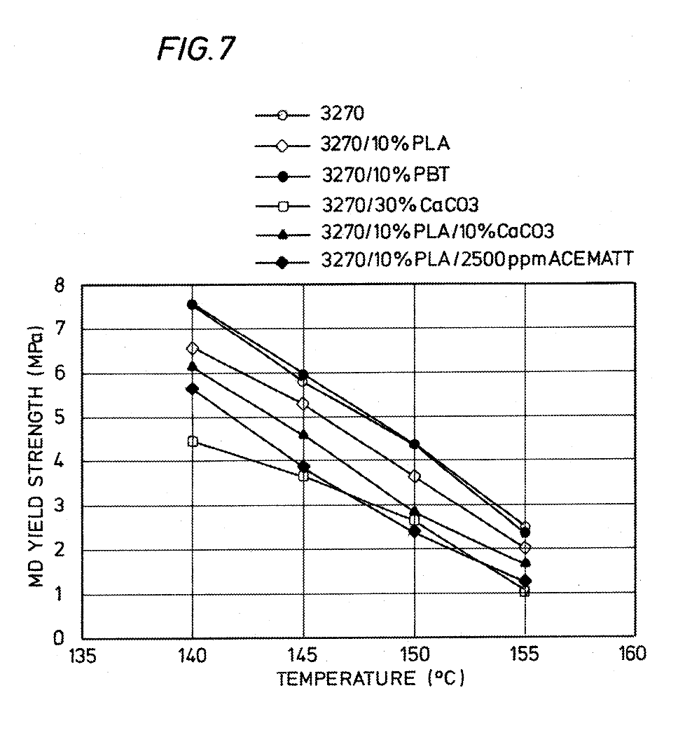

Haze versus process temperature at orientation stretching is shown in FIG. 5. Gloss at 45 degrees is shown in FIG. 6. MD stretch Yield Strength versus processing temperature at orientation stretching is shown in FIG. 7. As shown in FIG. 5, PP/PLA opaque films (e.g. >90% haze) were produced over a much broader temperature range (i.e. 140° C.-150° C.) by the addition of 10% CaCO₃ or addition of 2500 ppm Acematt matting agent. The broad processing window is comparable to those of PP/PBT and PP/CaCO3 technologies. FIG. 6 shows PP/PLA opaque films in this invention can be adjusted to have similar surface gloss as well as much glossier in film surface than commercial PP/PBT and PP/CaCO3 opaque films. Further, the PO/PLA blends could also be stretched at relatively low forces as shown in FIG. 7, indicating high BOPP productivity.

### Example 5

In Example 5, opaque films were made consistent with the processing conditions as described in Example 1. Opaque films made from PP/PLA blends were compared with those made from PP/PBT and PP/CaCO₃. PP/PLA opaque films exhibited similar low density, moisture barrier property to commercial technologies. The high stiffness of PP/PLA opaque films may result in additional potential for downgauging films compared with PP/PBT and PP/CaCO3 technologies.

TABLE 2

| | | WVTR | | Brk | Brk |
|---|---|---|---|---|---|
| | Density | g · day · | Modulus | strength | elongation |
| Sample Name | g/cc | 100 in² | kpsi | psi | % |
| 3270/PLA6202 | 0.642 | 0.89 | 237 | 19130 | 54 |
| 3270/PLA6202 opt. | 0.633 | — | 236 | 15500 | 45 |
| 3270/10% PBT | 0.576 | 0.91 | 194 | 14230 | 36 |
| 3270/30% CaC0₃ | 0.638 | 1 | 146 | 13480 | 57 |

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

What is claimed is:

1. A film comprising a polypropylene and a polylactic acid blend having a haze of from about 10% to about 100% and a gloss 45° of from about 50 to about 150.

2. The film of claim 1 wherein the polypropylene further comprises a polypropylene homopolymer, a high crystallinity polypropylene, a polypropylene heterophasic copolymer, a polypropylene copolymer, or combinations thereof.

3. The film of claim 1 with a DSC first melting point of 160° C. to 170° C.

4. The film of claim 1 wherein: the polypropylene is present in an amount of from 51 wt. % to 99 wt. % by weight of the blend, and the polylactic acid is present in an amount of 1 wt. % to 40 wt. % by weight of the blend.

5. The film of claim 1 further comprising a cavitating booster which comprises a polypropylene functionalized with a maleated PP.

6. The film of claim 1 further comprising a silica-based matting agent.

7. The film of claim 6, wherein the silica-based matting is present in an amount of between 0.1% and 2% by weight of the blend.

8. The film of claim 1 further comprising an inorganic filler.

9. The film of claim 1, wherein the ratio of the PO to PLA in the PO/PLA blend is between 4:1 and 199:1.

10. The film of claim 8 wherein the inorganic filler comprises calcium carbonate, titanium dioxide, kaolin, alumina trihydrate, calcium sulfate, talc, mica, glass microspheres, or combinations thereof.

11. The film of claim 10 wherein the inorganic filler is calcium chloride and the calcium chloride is present in an amount of from 1% to 30% by weight of the blend.

12. An opaque film comprising of a polylactic acid and polypropylene blend having a haze of about 90%-100% and a gloss 45° of from about 20 to about 150.

13. The film layer of claim 12 wherein the film is biaxially oriented.

14. The film of claim 12 having an opaque film density of between 0.50 and 0.70 g/cc as measured by ASTM D792.

15. The film of claim 12 having an opaque film modulus of between 200 and 250 kpsi as measured by ASTM D882.

16. The film of claim 12 having a break strength of between 12,000 and 23,000 psi as measured by ASTM D882.

17. The film of claim 12 having a break elongation between 30% and 80% as measured by ASTM D882.

18. The film of claim 12 wherein the machine direction yield strength as measured by bi-axial stretching by Bruckner lab stretcher ranges from about 1 MPa to about 10 MPa.

19. The film of claim 12, wherein the film is a single layer film.

20. The film of claim 12, wherein the film has a plurality of layers, wherein at least one of the layers is comprised of syndiotactic polypropylene, low density polyethylene, linear low density polyethylene, medium density polyethylene, high density polyethylene, ethylene-propylene copolymers, butylenes-propylene copolymers, ethylene-butylene copolymers, ethylene-propylene-butylene terpolymers, ethylene-vinyl acetate copolymers, ethylene-vinyl alcohol copolymers, nylons, or combinations thereof.
